(19) United States
(12) Patent Application Publication
(10) Pub. No.: US 2008/0319850 A1
(43) Pub. Date: Dec. 25, 2008

(54) Method for managing website advertising space

(75) Inventors: Rotem Shaul, Bat Yam (IL); Oren Berdichevsky, Kfar-Sava (IL); Eldad Avitan, Tel Aviv (IL); Eyal Betzalel, Tel Aviv (IL)

Correspondence Address: Pearl Cohen Zedek Latzer, LLP, 1500 Broadway, 12th Floor, New York, NY, 10036, US

(73) Assignee: SEKINDO LTD

(21) Appl. No.: 11/820,678

(22) Filed: Jun. 20, 2007

(51) Int. Cl. G06Q 30/00

(52) U.S. Cl. 705/14

(57) ABSTRACT

Method for managing website advertising space, according to which advertisers access a service provider server, which is dedicated to manage website advertising space of authorized host sites. Each advertiser is associated with a corresponding advertiser server and each of the host sites is associated with a corresponding host site server. The advertiser uploads an advertisement and/or advertiser data, such as target website characteristics and budgetary information, to a database of the service provider server. The host site administrator defines advertising spaces in that site. An executable code that is linkable with the service provider server is embedded within each advertising space of a host site web page and then the host site administrator searches the database and selects an advertisement to be displayed. The service provider server associates an advertising space with the selected advertisement and then a user accesses the host site web page. Identified data is then transmitted with the associated advertising space the executable code associated with the service provider server and the selected advertisement program file is displayed within the associated advertising space.

### FIELD OF THE INVENTION

The present invention relates to the field of electronic commerce. More particularly, the invention relates to a method for managing website advertising space.

### BACKGROUND OF THE INVENTION

Website administrators continually seek different ways to increase revenues of their website. One common approach is by means of advertisements that are displayed at predetermined regions of the website (hereinafter “advertisement spaces”).

Many prior art publications disclose a networked advertising auction method for optimizing revenues from advertising spaces.

U.S. Pat. No. 6,285,987 issued to Roth et al discloses an Internet advertising system by which proposed bids submitted by different advertisers are evaluated in real time in order to determine which particular advertisement will be displayed to a viewer. Each proposed bid can specify a price or amount that the advertiser is willing to pay for the opportunity to display an advertisement to a viewer who has a particular set of characteristics and on a web site and web page that meets a particular set of criteria.

In U.S. Pat. No. 7,085,732 issued to Gould, an online session is conducted with the advertiser to form an auction ticket that specifies the price the advertiser is willing to pay for the advertisement, as well as dates the advertisement is to run, color preference, placement on a page, and a list of media outlets from whom the advertiser wants to solicit bids. The media outlets are notified of the auction and given the auction ticket. Bids are submitted by specifying the amount of advertising space the media outlet is willing to allot for the specified price.

Levy et al in US 2006/0259408 and Klopf et al in US 2007/0011050 also disclose a method for facilitating purchasing of advertising via electronic auction.

These prior art methods are operable with respect to a system that automatically embeds advertisements within a website, or alternatively, one that enables advertisers to bid for an advertising space with respect to data entered by the website administrator and advertiser. The advertisement is consequently not accessible to the website administrator, and certainly the website administrator cannot directly and immediately select a desired advertisement, e.g. one that is compatible with the interests of most users that interact with the given website. Also, valuable website computer resources are ineffectively utilized in order to determine which bidder will win the auction, and therefore website expenditures are increased.

It is an object of the present invention to provide a method for managing website advertising space, for which revenue is raised without need of electronic auctions.

It is an additional object of the present invention to provide a method for selecting an advertisement to be displayed within a website advertising space, by which advertisement derived revenues can be optimized.

It is an additional object of the present invention to provide a method by which a website administrator can view the content of a proposed advertisement and determine whether it is compatible with the interests of most users that interact with the given website.

It is yet an additional object of the present invention to provide a method for managing website advertising space, by which the criteria for selecting an advertisement to be displayed within a given advertising space are clearly and publicly known.

Other objects and advantages of the invention will become apparent as the description proceeds.

### SUMMARY OF THE INVENTION

The present invention provides a method for managing website advertising space, comprising the steps of:

a) Authorizing a plurality of advertisers access to a service provider server dedicated to manage website advertising space of authorized host sites, each of said advertisers being associated with a corresponding advertiser server and each of said host sites being associated with a corresponding host site server;

b) Advertiser initiated uploading of an advertisement program file and of advertiser data to a database of said service provider server, said advertiser data including target website characteristics and budgetary information related to advertisements to be displayed at a target website;

c) Host site administrator defines advertising spaces in that site;

d) Embedding within each advertising space of a host site web page a first executable code that is linkable with said service provider server;

e) Host site administrator initiated searching of said database;

f) Host site administrator initiated selecting of an advertisement program file to be displayed in an advertising space;

g) Associating, by said service provider server, an advertising space with said selected advertisement program file;

h) Accessing the host site web page by a user;

i) Transmitting identifying data with the associated advertising space by means of said first executable code associated with said service provider server; and

j) Displaying the selected advertisement program file within the associated advertising space.

The identifying data associated with the associated advertising space is transmitted to the service provider server also by means of a user browser which is adapted to download the first embedded executable code together with the associated identifying data upon accession to the host site web page. The first embedded executable code is adapted to initiate the transmission of a copy of the selected advertisement program file from the database to the associated advertising space and to initiate the display of the selected advertisement program file within the associated advertising space.

Preferably, the service provider server is operable to transmit a copy of the selected advertisement program file from the database to the user browser when the selected advertisement program file is found to be unbarred.

The host site administrator selects, for each advertising space, backup advertisement program files in anticipation of an advertising barring event.

In one aspect, the host site administrator selects for each advertising space, in anticipation of an advertising barring event a group of one or more files, while all advertisement program files are associated with priority in a descending order. The unbarred advertisement program file with the highest priority is transmitted to the user browser.

An advertising barring event is initiated following the occurrence of any of the following events:
a) A budget is exhausted, with respect to a specified budget allocation method;
b) The advertiser transmitted a request message to the service provider server to bar the advertisement of a specified advertisement;
c) The advertiser transmitted a request message to the service provider server to bar the advertisement of a specified advertisement on a specified host site;
d) A specified advertising period has elapsed;
e) The advertiser has modified previously submitted advertising data, including advertising cost, pricing structure, and target website characteristics, resulting in less compatibility between the advertisement program file and the host site; and
f) Entered target advertisement geographical characteristics are not compatible with those of the user, as established by his IP address.

In one aspect, an automatic mode is invoked when an advertising barring event is initiated on all advertisement program files, associated with the advertising space.

An advertisement program file is transmitted during the automatic mode by performing the following steps:
a) comparing the characteristics of all advertisement program files approved for the automatic mode and that still have a budget with the characteristics of the advertising space and user IP address;
b) identifying compatible characteristics;
c) filtering compatible characteristics;
d) comparing the characteristics of all filtered advertisement program files with the characteristics of the barred advertisement program files, selected by the host site administrator;
e) identifying compatible characteristics;
f) filtering compatible characteristics; and transmitting the most compatible advertisement program file to the user browser.

In one aspect, the service provider server transmits a compatible advertisement program file by a random process or by a revenue optimization process when two or more advertisement program files are found to have a substantially equal compatibility.

In one aspect, the entered advertiser data includes a website approval method, which can be implemented a-priori or explicitly (i.e., each time a host site administrator selects the advertisement program file, the advertiser will get a notification asking him to approve or reject the association of his advertisement program file with the advertising space).

In one aspect, the assigned advertisement program file is transmitted to the user browser, following user accession to the host site, only when the service provider server determines that the advertiser approved the display of the advertisement during the automatic mode.

In one aspect, a second executable code that is linkable with the service provider server is embedded within the associated advertising space once the copy of the selected advertisement program file is transmitted to the associated advertising space. When a user clicks the associated advertising space, the second embedded executable code links the user browser with the service provider server, whereupon the user browser is linked with a URL determined by the advertiser.

The method preferably further comprises the following steps:
a) Transmitting a first or a second, accession data by means of a first and a second embedded executable codes, respectively to a monitoring module in communication with the service provider server;
b) Service provider performed billing of the advertiser based on said accession data and on the budgetary information;
c) Receiving payment from the advertiser;
d) Receiving a commission for said payment; and
e) Transmitting said payment to the host site,
   wherein the first accession data is transmitted whenever the advertisement is viewed and the second accession data is transmitted whenever the user clicks on the advertisement.

### BRIEF DESCRIPTION OF THE DRAWINGS

In the drawings:

FIG. 1 is a schematic illustration of a website advertising space management system, according to one embodiment of the invention;

FIG. 2 is a schematic illustration of an exemplary advertiser data form that needs to be completed and submitted during an advertisement file uploading operation;

FIG. 3 is a flow chart that illustrates a method for managing website advertising space, according to one embodiment of the invention;

FIG. 4 is a flow chart that illustrates a method for billing advertisers for which a corresponding advertisement has been displayed on a host site;

FIG. 5 is a flow chart that illustrates a method for transmitting a backup advertisement file when a primary advertisement file is barred; and

FIG. 6 is a flow chart that illustrates a method by which the service provider server automatically transmits the advertisement program files to the user's browser.

### DETAILED DESCRIPTION OF PREFERRED EMBODIMENTS

The present invention is a novel method for managing website advertising space by which an independent website dedicated to optimize advertisement derived revenues (hereinafter “the service provider”) provides a database of electronically accessible advertisements transmitted thereto by authorized subscribers (hereinafter “advertisers”). Authorized administrators of a plurality of websites that are desirous of raising advertisement derived revenues (hereinafter “host sites”) are able to access the database and to determine which of the stored advertisements has a content that is compatible with the interests of most users that interact with the given host site. Advertisement selections made by a host site administrator are accessible to the host sites and advertisers. By virtue of service provider credibility and increased revenue for both host sites and for advertisers, the service provider attracts host site administrators and advertisers by reverse marketing whereby the latter two initiate a working agreement with the service provider to receive advertising space management services.

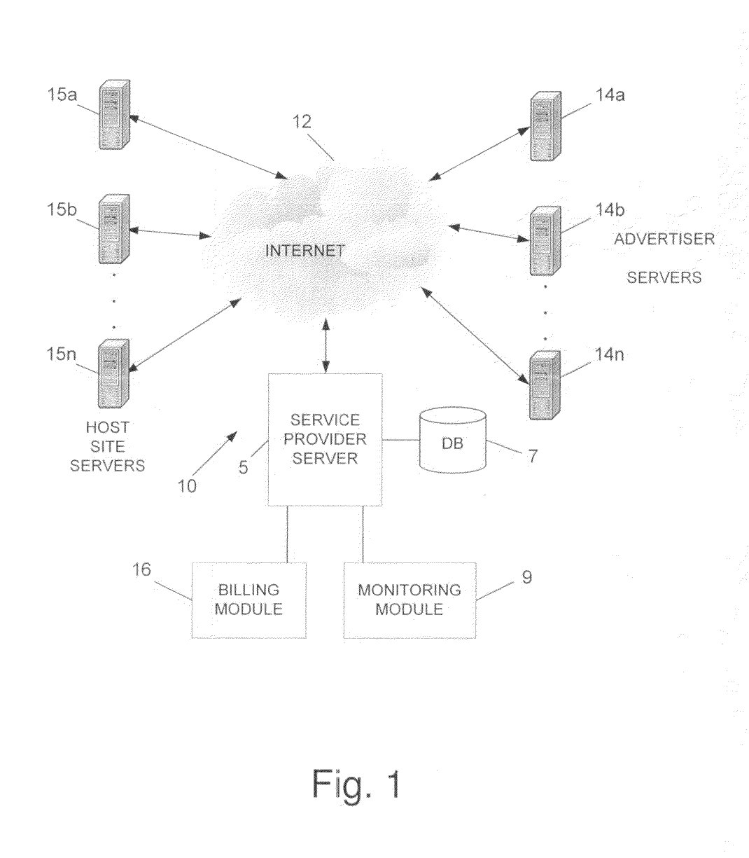

FIG. 1 schematically illustrates a website advertising space management system, according to one embodiment of the invention, and is designated by numeral 10. Advertising space management system 10 comprises service provider server 5 in communication with Internet 12, database 7 in communication with service provider server 5 for storing a plurality of electronically accessible advertisement program files and host site and advertiser data, monitoring module 9 in communication with service provider server 5 for monitoring the accession of advertisement program files, billing module 16 in communication with service provider server 5, a plurality of advertiser servers 14a, 14b . . . 14n in communication with Internet 12 for uploading a corresponding advertisement program file and transmitting corresponding advertiser data to database 7, and a plurality of host site servers 15a, 15b . . . 15n in communication with Internet 12. A host site administrator is able to search database 7, in order to select advertisements that are compatible with the host site. After the host site administrator selects an advertisement program file, the selected advertisement program file is associated by the service provider with the host site's advertising space. The host site administrator embeds a unique code into the HTML page for each advertising space, which retrieves a corresponding advertisement from the database upon user initiated accession of a host site webpage. After a user accesses the host site web page, an advertisement is transmitted to the advertising space, and additionally, data which is indicative that the advertisement file has been viewed is transmitted to monitoring module 9. Optionally, the user may click an advertisement and in response, data which is indicative that the advertisement file has been clicked is transmitted to monitoring module 9. Monitoring module 9 stores accumulative accession data, which is indicative of the number of times that the advertisement file has been viewed or clicked during a given period and by which advertiser fees can be calculated, as will be described hereinafter.

The advertisement program file that is transmitted to an advertising space can be adapted to provide or generate any desired display including an advertisement appearing as a banner, a pop-up advertisement, pop-under advertisement, interstitial advertisement, inline advertisement and floating advertisement, as well known to those skilled in the art.

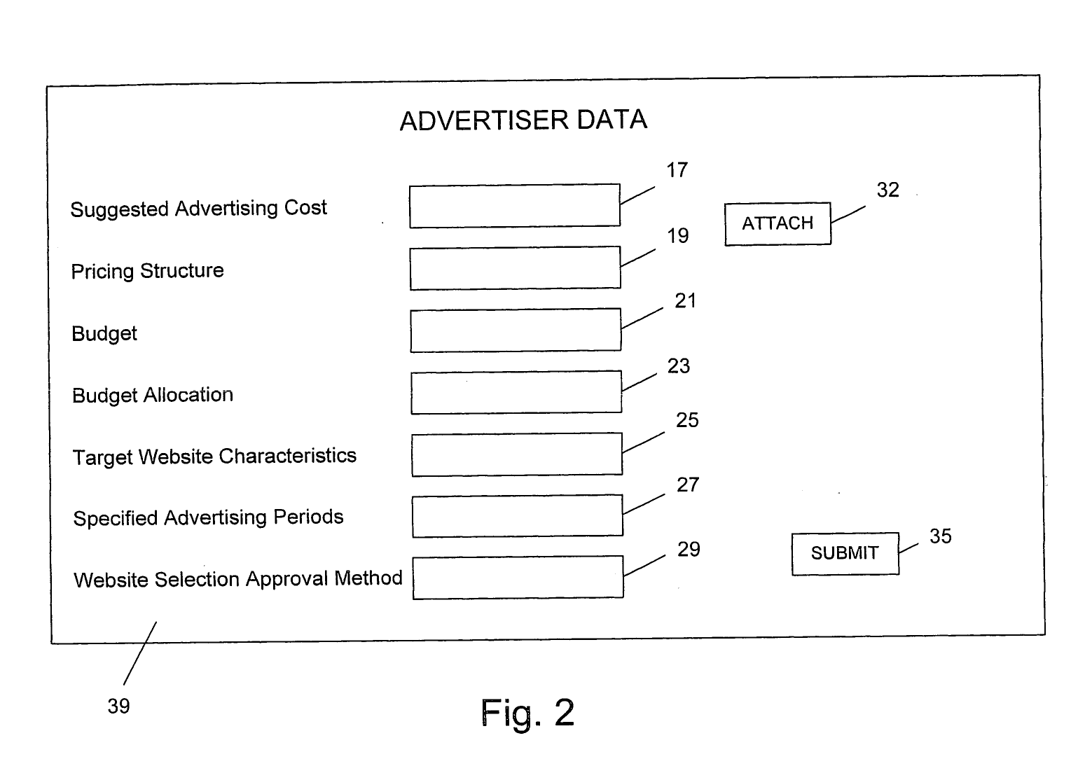

As shown in FIG. 2, an advertiser data form 39 needs to be completed and submitted during an advertisement file uploading operation. When an advertiser is desirous of performing an advertisement file uploading operation, the service provider server is accessed and advertiser data form 39 is downloaded. The following fields in form 39 need to be completed prior to submission:
1. Suggested Advertising Cost (Field 17)—The payment that the advertiser is willing to pay to a host site with respect to a specified pricing structure for displaying the advertisement.
2. Pricing Structure (Field 19)—The method by which the suggested advertising cost is paid. One determining factor that establishes a charge for the advertiser is a click, i.e. an act denoting the selection of an advertisement being displayed within the advertising space by a pointing device such as a mouse of a user, linking a user browser with a corresponding advertiser web page via the service provider server. The pricing structure may define a click as a unique click, which is indicative that a user that has not clicked an advertisement for a predetermined period of time has clicked an advertisement being displayed within the advertising space. The advertiser may be charged on a Cost per Click (CPC) basis, or any other suitable pricing structure. The pricing structure may also be based on an impression whereby the user has accessed the host site and viewed an advertisement being displayed within the advertising space, or as a unique impression whereby a user that has not viewed an advertisement for a predetermined period of time has accessed the host site and viewed the advertisement.
3. Budget—(Field 21)—The global budget that the advertiser is willing to pay to display the advertisement. The budget may be defined as being infinite, meaning that the advertiser is committed to constantly pay the advertising costs.
4. Budget Allocation (Field 23)—The method by which the budget is allocated. If a periodic budget allocation is not specified, the advertisement will be displayed until the aggregate sum entered in field 21 is utilized, as defined by the advertising cost and price structure. If a periodic budget allocation is specified, e.g. $100 per day, the advertisement will be displayed until the sum entered in field 23 is utilized during the specified period, as defined by the advertising cost and price structure. Both a global and periodic budget allocation may be specified, so that the advertisement will be displayed for a limited period of time during a day, for a limited number of days.
5. Target Website Characteristics (Field 25)—The characteristics of those websites of which the advertiser is desirous of displaying the advertisement, including demographic, geographic and psychographic characteristics of typical users that interact with the host site, the nature of information displayed on the host site, the relative location within a web page at which the advertisement is to be displayed, and the size of the advertising space. The advertiser may also specify negative characteristics, namely those characteristics that would preclude selection thereof by the service provider.
6. Specified Advertising Periods (Field 27)—The periods of time during which the advertisement is to be displayed, including specified days or specified hours.
7. Website Selection Approval Method (Field 29)—The advertiser specifies the method by which he approves the host site at which the advertisement is to be displayed, for example, whether he provides a priori approval for any host site associated with the advertisement or requests that the advertisement not be displayed on the host site until providing explicit approval for the selected host site. In addition the advertiser may approve the display of the advertisement during the automatic mode.

After form 39 is completed, the advertiser by means of button 32 attaches the desired advertisement program file to the file defined by the completed form 39 and then submits the form by means of button 35 to the database of the service provider server.

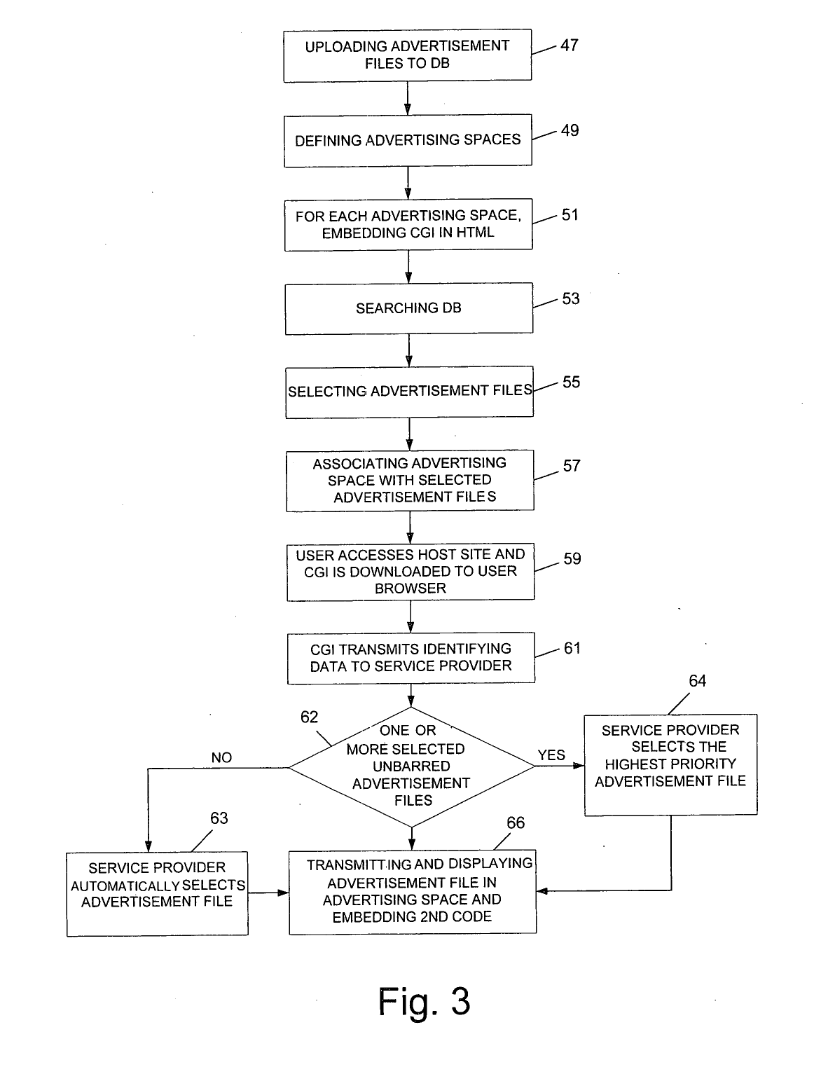

FIG. 3 illustrates a method for managing website advertising space, according to one embodiment of the invention. A first step 47 for the method of the invention is the step of uploading advertisement program files, together with the corresponding advertiser data, from each corresponding advertiser server to the database of the service provider server. Only those advertisers that are authorized by the service provider can perform an advertisement file uploading operation to the database. After advertisement program files are uploaded to the database in step 47, the database is automatically updated, so as to categorize the stored files according to one or more data categories described hereinabove with respect to FIG. 2.

Prior to selecting a desired advertisement to be displayed, the host site administrator defines in step 49 one or more advertising spaces of the host site, in which an advertisement is to be displayed, including their characteristics, such as demographic, geographic and psychographic characteristics of typical users that interact with the host site, the nature of information displayed on the host site, the relative location within a web page at which the advertisement is to be displayed, and the size of the advertising space. It will be appreciated that the host site can provide a limitless number of advertising spaces, if so desired. The host site administrator receives from the service provider a unique executable code, which is interfaceable with the service provider server, for each advertising space that is defined, e.g. a Common Gateway Interface (CGI) program, and embeds in step 51 each of the unique executable codes within the source code of a HyperText Markup Language (HTML) page of the host site. Each embedded executable code, when initiated, is able to transmit data which identifies a given advertising space to the service provider server.

Authorized advertisers and host site administrators can search the database in step 53. Advertisers search the database in order to review the advertising cost suggested by their competitors for desired target websites. Stored advertisement program files can be retrieved and displayed by host site administrators. Thus host site administrators can search the database for advertiser data, such as website characteristics and advertising cost, which can on one hand maximize advertisement derived revenues, while on the other hand can determine whether the content of an advertisement is compatible with the interests of most users that interact with the host site. By referring to the specified advertising periods of each advertiser and scheduling selected advertisements to be sequentially displayed in a given advertising space from one advertising period to another, e.g. a first advertisement will be displayed during a period from 12 PM to 2 PM and a second advertisement will be displayed during a period from 2 PM to 6 PM, the host site administrator is able to maximize revenue from the advertising space.

While searching the database, the host site administrator selects advertisement program files in step 55, and submits the selection to the service provider server, together with the advertising space designation within which the selected advertisement program file is to be displayed. The host site administrator may select more than one advertisement program file to be displayed in a given advertising space, in which case the host site administrator will also define the priorities, according to which the advertisement program files are to be displayed in the advertising space. The service provider server associates in step 57 the given advertising space with selected advertisement program files and the displaying priority thereof, if defined. It will be appreciated that at any time the host site administrator may add other advertisement program files to be associated with the given advertising space, or to delete advertisement program files that have been previously associated with the given advertising space, after a selection is submitted.

When a user accesses the host site during a given advertising period after the advertising spaces thereof have been associated with one or more corresponding advertisement program files, the embedded CGI and the associated identifying data are downloaded to the user browser in step 59.

The downloaded CGI is operable to transmit the associated identifying data, and optionally also the Internet Protocol (IP) address of the user, to the service provider server in step 61. If the service provider server determines in step 62 that all selected advertisement program files have been barred, the service provider server automatically selects advertisement program file in step 63. If the service provider server determines in step 62 that a given advertising space has been associated with one or more unbarred advertisement program files, the service provider server selects in step 64 the advertisement program file of highest displaying priority, as defined by the host site administrator in step 55. The criteria for an advertising barring event will be described hereinafter. The advertisement program file which was selected in steps 63 or 64 is transmitted and then displayed in the advertising space in step 66. A second executable code, which is linked to the service provider's server associated with the transmitted advertisement program file, is transmitted to the user browser concurrently with the transmission of the advertisement program file and embedded within the advertising space. It will be appreciated that steps 59-66 will be performed concurrently for all advertising spaces defined by the host site administrator in step 49.

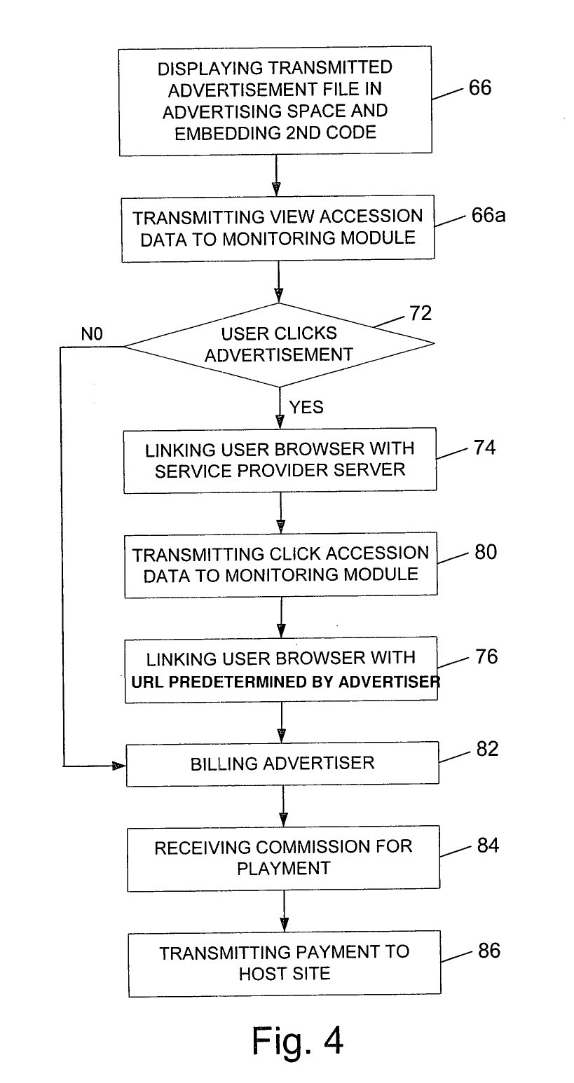

With reference to FIG. 4, view accession data which is indicative of a user initiated accession of the host site is transmitted to the monitoring module in step 66a after a transmitted advertisement program file has been displayed in a corresponding advertising space in step 66. Alternatively, click accession data which is transmitted to the monitoring module in step 80 after a transmitted advertisement program file has been clicked in a corresponding advertising space. Each accession data is generated by the CGI upon display (or optionally after clicking) of the advertisement program file within the corresponding advertising space, and is transmitted to the monitoring module via the service provider server together with the associated identifying data of the advertising space. The service provider serves as an intermediary between the advertiser and host site, billing the advertiser in step 82 after a predetermined period of time for the sum of budget that has been utilized as a result of user accession to the advertising space, either by viewing or by clicking. After receiving a payment from the advertiser, the service provider receives a commission in step 84 and transmits the payment to the host site in step 86.

When a user clicks the advertisement which is displayed within an advertising space during the given advertising period in step 72, the user's browser executes the second executable code, linking the user browser with the service provider server in step 74, which in turn links the user browser with the URL predetermined by the advertiser and associated with the transmitted advertisement program file in step 76. When an advertisement is being clicked in the host site, accession data is transmitted to the monitoring module in step 80. Steps 82-86 are then performed as described hereinabove.

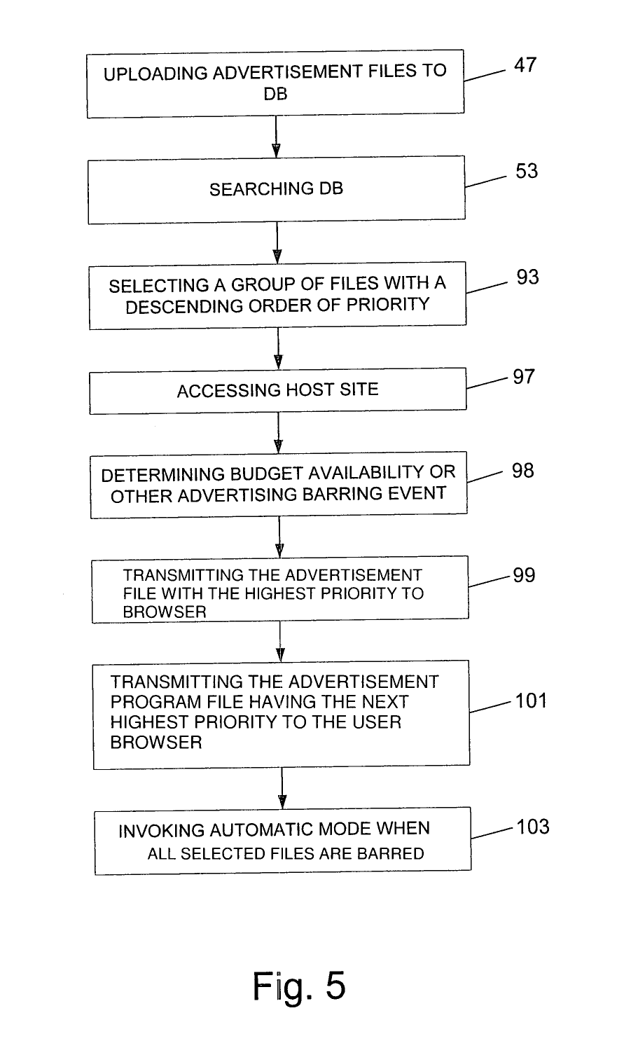

As shown in FIG. 5, revenue from the advertising space can be further increased by selecting more than one advertisement to be displayed during a given period, so as to backup any barring event. Accordingly, the host site administrator selects in step 93 one or more advertising program files with priorities having a predetermined descending order (determined by the host site administrator) for a given advertising space, to be displayed during a given period. It will be appreciated that all advertisement files can be selected for more than one advertising space, if so desired. After being selected, the primary and other advertising program files are associated with the advertising space and stored at a high internet-bandwidth location of the service provider server, e.g. 90 gigabit/s, so that they may be instantly transmitted to the advertising space on demand.

After a user accesses the host site in step 97 during a given advertising period, identifying data associated with an advertising space is transmitted to the service provider server, as described hereinabove. The service provider server then determines in step 98, based on the accumulated accession data, advertising cost, pricing structure, and budget allocation method, whether a sufficient sum remains in the budget to allow the advertisement to be displayable on the host site. When a sufficient sum remains in the budget, the primary advertising program file (having the highest priority) is transmitted in step 99 to the browser of the user and is subsequently displayed within the advertising space. When the budget is found to be exhausted, or any other advertising barring event relating to the primary program file has been found to have been initiated, the secondary advertising program file (having the highest priority among the remaining advertisements) is transmitted to the user browser in step 101. Third files, or any other number of backup advertisement program files, can also be selected by the host site administrator. When all selected advertisement program files have been barred, an automatic mode is invoked in step 103, as will be described hereinafter, and a message is transmitted from the service provider server to the host site server indicating that the automatic mode has been invoked.

An advertising barring event is initiated following the occurrence of any of the following events:
1. The budget is exhausted, with respect to the specified budget allocation method.
2. The advertiser transmitted a request message to the service provider server to bar the advertisement of a specified advertisement.
3. The advertiser transmitted a request message to the service provider server to bar the advertisement of a specified advertisement on a specified host site.
4. The specified advertising period has elapsed.
5. The advertiser has modified some of the previously submitted advertising data, including advertising cost, pricing structure, and target website characteristics, resulting in less compatibility between the advertisement program file and the host site.
6. The entered target advertisement geographical characteristics are not compatible with those of the user, as established by his IP address.

The host site administrator performs this method for each advertising space on the host site. The service provider server may transmit an alert message to the host site server indicating that the revenue derived from the plurality of advertisements displayable on the host site is not optimal. The service provider server generates such an alert message, for example, when an advertisement program file has not been assigned by the host site administrator to be displayed on a given advertising space during one or more advertising periods. An alert message will also be generated and transmitted when the service provider server anticipates, based on the level of the outstanding budget and other billing data, that the budget will be exhausted during the present advertising period and that the automatic mode will be invoked. The host site administrator may transmit a request message to the service provider at any time to determine whether the revenue derived from the plurality of advertisements displayable on the host site is not optimal.

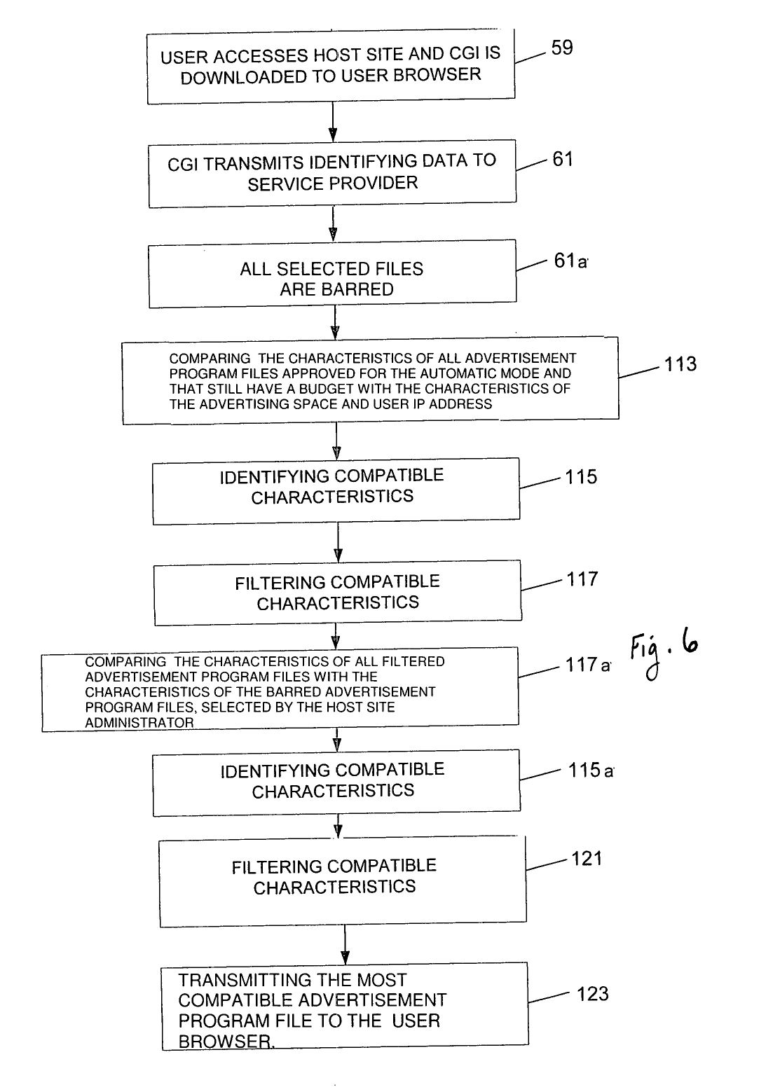

FIG. 6 illustrates an embodiment of the invention in which the service provider server selects the advertisement program files to be transmitted to the user's browser. This selection method is applicable when the service provider server is operating in the automatic mode.

The host site administrator receives from the service provider a unique executable code, which is interfaceable with the service provider server, for each advertising space that is defined, e.g. a Common Gateway Interface (CGI) program, and embeds each of the unique executable codes within the source code of a HyperText Markup Language (HTML) page of the host site. When a user accesses the host site during a given advertising period after the advertising spaces thereof have been associated with one or more corresponding advertisement program files, the embedded CGI and the associated identifying data are downloaded to the user browser in step 59. The downloaded CGI is operable to transmit the associated identifying data, and optionally also the Internet Protocol (IP) address of the user, to the service provider server in step 61. At, step 61a, all the selected advertisement program files are barred. The service provider server processes the advertiser data and host site data, and first compares in step 113 the characteristics of all advertisement program files approved for the automatic mode and that still have budget with advertising space characteristics specified by the host site administrator and with the user IP address. Those advertisement program files that are specified with similar characteristics as the advertising space characteristics specified by the host site administrator are identified and filtered in steps 115 and 117, accordingly. At step 117a, all the filtered advertisement program files are compared with the barred advertisement program files, selected by the host site administrator. At step 115a, the advertisement program file with the characteristics which are the most compatible with the barred advertisement program files, is identified and then filtered in step 121.

Needless to say, the pricing structure, budget, and budget allocation generally varies from one advertiser to another, and the various billing parameters are converted to a single parameter which is used as a basis of comparison. If two advertisement program files are found to have a substantially equal compatibility, the service provider server will select one of them by a random process or by a revenue optimization process. The selected advertisement program file will be transmitted to the user browser in step 123.

It will be appreciated that the host site administrator can transmit a request message to the service provider server to bar the display within the host site of an advertisement that has been selected in the automatic mode, if for example, the displayed advertisement program file is found to be not compatible with the needs of the host site. The host site administrator may override the automatic mode if a desired advertisement program file is selected to be displayed.

It will be appreciated that the service provider may serve as an intermediary to communicate between a host site and advertiser, for example, if the host site administrator is satisfied with the content of an advertisement, but wishes that the advertisement be slightly modified, such as to modify the size of the advertisement or to modify its background color.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A method for managing website advertising space, comprising the steps of
a) Authorizing a plurality of advertisers access to a service provider server dedicated to manage website advertising space of authorized host sites, each of said advertisers being associated with a corresponding advertiser server and each of said host sites being associated with a corresponding host site server;
b) Advertiser initiated uploading of an advertisement program file and of advertiser data to a database of said service provider server, said advertiser data including target website characteristics and budgetary information related to advertisements to be displayed at a target website;
c) Host site administrator defines advertising spaces in that site;
d) Embedding within each advertising space of a host site web page a first executable code that is linkable with said service provider server;
e) Host site administrator initiated searching of said database;
f) Host site administrator initiated selecting of an advertisement program file to be displayed in an advertising space;
g) Associating, by said service provider server, an advertising space with said selected advertisement program file;
h) Accessing the host site web page by a user;
i) Transmitting identifying data with the associated advertising space by means of said first executable code associated with said service provider server; and
j) Displaying the selected advertisement program file within the associated advertising space.

2. The method according to claim 1, wherein the identifying data associated with the associated advertising space is transmitted to the service provider server also by means of a user browser which is adapted to download the first embedded executable code together with the associated identifying data upon accession to the host site web page.

3. The method according to claim 2, wherein the first embedded executable code is adapted to initiate the transmission of a copy of the selected advertisement program file from the service provider's database to the associated advertising space and to initiate the display of the selected advertisement program file within the associated advertising space.

4. The method according to claim 3, wherein the service provider server is operable to transmit a copy of the selected advertisement program file from the database to the user browser when the selected advertisement program file is found to be unbarred.

5. The method according to claim 4, wherein the host site administrator selects, for each advertising space, backup advertisement program files in anticipation of an advertising barring event.

6. The method according to claim 5, wherein the host site administrator selects for each advertising space, in anticipation of an advertising barring event, a group of one or more files, while all advertisement program files are associated with priorities in a descending order, and the unbarred advertisement program file having the highest priority is transmitted to the user browser.

7. The method according to claim 5, wherein an advertising barring event is initiated following the occurrence of any of the following events:
a) A budget is exhausted, with respect to a specified budget allocation method;
b) The advertiser transmitted a request message to the service provider server to bar the advertisement of a specified advertisement;
c) The advertiser transmitted a request message to the service provider server to bar the advertisement of a specified advertisement on a specified host site;
d) A specified advertising period has elapsed;
e) The advertiser has modified previously submitted advertising data, including advertising cost, pricing structure, and target website characteristics, resulting in less compatibility between the advertisement program file and the host site; and
f) Entered target advertisement geographical characteristics are not compatible with those of the user, as established by his IP address.

8. The method according to claim 5, wherein an automatic mode is invoked when an advertising barring event is initiated on all advertisement program files associated with the advertising space.

9. The method according to claim 8, wherein an advertisement program file is transmitted during the automatic mode by performing the following steps:
a) comparing the characteristics of all advertisement program files approved for the automatic mode and that still have a budget with the characteristics of the advertising space and user IP address;
b) identifying compatible characteristics;
c) filtering compatible characteristics;
d) comparing the characteristics of all filtered advertisement program files with the characteristics of the barred advertisement program files, selected by the host site administrator;
e) identifying compatible characteristics;
f) filtering compatible characteristics; and
g) transmitting the most compatible advertisement program file to the user browser.

10. The method according to claim 9, wherein the service provider server transmits a compatible advertisement program file by a random process or by a revenue optimization process when two or more advertisement program files are found to have a substantially equal compatibility.

11. The method according to claim 1, wherein the entered advertiser data includes a website approval method, which can be implemented a-priori or explicitly.

12. The method according to claim 1, wherein the advertiser may approve the display of the advertisement during the automatic mode.

13. The method according to claim 12, wherein the selected advertisement program file is transmitted to the user browser, following user accession to the host site, only when the service provider server determines that the advertiser approved the corresponding advertisement program file to be displayed in the automatic mode.

14. The method according to claim 4, wherein a second executable code that is linkable with the service provider server is embedded within the associated advertising space once the copy of the selected advertisement program file is transmitted to the associated advertising space.

15. The method according to claim 13, wherein a second executable code that is linkable with the service provider server is embedded within the associated advertising space once the copy of the selected advertisement program file is transmitted to the associated advertising space.

16. The method according to claim 14, wherein the second embedded executable code links the user browser with the service provider server once a user clicks the associated advertising space, whereupon the user browser is linked with a URL determined by the advertiser.

17. The method according to claim 15, wherein the second embedded executable code links the user browser with the service provider server once a user clicks the associated advertising space, whereupon the user browser is linked with a URL determined by the advertiser.

18. The method according to claim 3, further comprises the following steps:
a) Transmitting a first or a second accession data by means of a first and a second embedded executable code respectively, to a monitoring module in communication with the service provider server;
b) Service provider performed billing of the advertiser based on said accession data and on the budgetary information;
c) Receiving payment from the advertiser;
d) Receiving a commission for said payment; and
e) Transmitting said payment to the host site,
wherein the first accession data is transmitted whenever the advertisement is viewed and the second accession data is transmitted whenever the user clicks on the advertisement.

19. The method according to claim 14, further comprises the following steps:
f) Transmitting a first or a second accession data by means of a first and a second embedded executable code respectively, to a monitoring module in communication with the service provider server;
g) Service provider performed billing of the advertiser based on said accession data and on the budgetary information;
h) Receiving payment from the advertiser;
i) Receiving a commission for said payment; and
j) Transmitting said payment to the host site,
wherein the first accession data is transmitted whenever the advertisement is viewed and the second accession data is transmitted whenever the user clicks on the advertisement.

20. The method according to claim 15, further comprises the following steps:
k) Transmitting a first or a second accession data by means of a first and a second embedded executable code respectively, to a monitoring module in communication with the service provider server;
l) Service provider performed billing of the advertiser based on said accession data and on the budgetary information;
m) Receiving payment from the advertiser;
n) Receiving a commission for said payment; and
o) Transmitting said payment to the host site,.
wherein the first accession data is transmitted whenever the advertisement is viewed and the second accession data is transmitted whenever the user clicks on the advertisement.
